(19) United States
(12) Patent Application Publication
(10) Pub. No.: US 2019/0313618 A1
(43) Pub. Date: Oct. 17, 2019

(54) Aero Dynamic Fishing Float

(71) Applicant: Michael Q. Hoang, Fort Worth, TX (US)

(72) Inventor: Michael Q. Hoang, Fort Worth, TX (US)

(21) Appl. No.: 16/382,772

(22) Filed: Apr. 12, 2019

Related U.S. Application Data
(60) Provisional application No. 62/656,793, filed on Apr. 12, 2018.

(51) Int. Cl. A01K 93/00; A01K 95/02

(52) U.S. Cl. CPC A01K 93/00; A01K 95/02

(57) ABSTRACT

An aerodynamic fishing assistant is disclosed. The fishing assistant comprises a float with an opening. The fishing assistant further comprises a shaft having a first end and a second end, wherein the second end is configured to slidably positioned into the opening of the float from a bottom portion and affixed to a top portion of the float by a fastening assembly comprises a cupped washer, a bead, and an eyelet. The float further comprises a weight member adhesively bonded on the bottom portion of the float. A lead line with a hook securely affixed to the eyelet at the top portion of the float using a swivel and a clip, thereby accurately casting the float and the lead line with the hook out to a target destination into the water for fishing and prevents the lead line from being tangled to a fishing rig by spinning of the float.

### BACKGROUND OF THE INVENTION

### A. Technical Field

The present invention generally relates to an aerodynamic fishing assistant. More specifically, the present invention relates to a fishing assistant for providing a streamlined shape with a weight member at the bottom of the float.

### B. Description of Related Art

Typically, fishing is a hunting process with most fish captured wild and techniques include hand gathering, spearing, angling, netting, and trapping. The hunters gather lifestyle of ancient peoples in a constant movement and migration out of necessity. Forced by nature to follow food sources many ancient peoples were nomads and very few permanent settlements were established. The few permanent settlements existed, who were almost sustained by fishing and a fishing culture. The establishment of fishing communities was not necessarily permanently occupied as resources available could shift, and prime fishing areas could be fished out, or environmental changes could take place forcing relocations. The introduction of boats greatly aided in the development of semi-established communities to last from the expansion of the range of fishing capacity. The ability of fishing to create a permanent settlement of humans is one of the first foundations of a sociological change that created the basis for modern civilization. The introduction of agriculture in addition to fishing is what fashioned the contemporary model of cities and townships that is recognized today.

However, fishing in its many forms is still a significant cultural phenomenon. For many people, fishing has become a pastime and a sport rather than a system and source of subsistence. The most popular form of fishing is performed using the fishing rod and line. There are many variations of fishing reels that contain the fishing line, and the types of lures and baits used are almost endless in variety. The fishing rod although out of practicality is not as variable still has many different forms available for an individual who wants to take up fishing. Utilizing the rod and reel to cast the bait or lure a significant distance allows the person to create a more substantial fishing zone around them that will enhance their chances of catching a fish at any given location. Fishing rigs with some arrangement of float and bait on them such as minnows or other systems of bait are particularly difficult to cast at any distance. The apparatus tends to swivel uncontrollably causing tangles, inaccurate castings, and a reduction of the possible range of the cast. Tangles prove to be very frustrating and reduces the enjoyment of a pleasurable experience. The inaccurate casting results in missing the desired landing location and the possible loss of the bait from the hook.

Further, the fisherman typically uses round bobbers which are clipped onto the line a distance above the hook/bait. A weight is placed between the float and the hook/bait. Upon casting, the line tends to whip around. It tends to fly in the air and reduce the accuracy and length of the cast, because the float is not weighted. Also, the bait/hook/weight tend to fly as well resulting in tangles sometimes, which require retrieval, detangling, and recasting.

Therefore, there is a need for an aerodynamic fishing assistant for providing a streamlined shape with a weight member at the bottom of the float.

### SUMMARY OF THE INVENTION

The present invention discloses an aerodynamic fishing assistant. More specifically, the present invention relates to a fishing assistant for providing a streamlined shape with a weight member at the bottom of the float.

In an embodiment, the aerodynamic fishing assistant has a specialized lead weight member attached to a float or an aerodynamic float. The aerodynamic float is attached to bait and hook via a single lead line. Further, the single lead line is attached with the aerodynamic float through a 3-way swivel and clip. In one embodiment, the float includes an opening along its central longitudinal axis. In one embodiment, a shaft having a first end with a stopper and a second end, wherein the second end is configured to slidably positioned into the opening of the float from a bottom portion and securely affixed to a top portion of the float by a fastening assembly comprising a cupped washer, a bead, and an eyelet. In one embodiment, the float is of an aerodynamic shaped member. In one embodiment, the float is made of an ethylene-vinyl acetate (EVA) foam. In some embodiments, the float is made of at least any one of a material includes Styrofoam® and plastic.

In one embodiment, a weight member is adhesively bonded on the bottom portion of the float. A lead line with a hook is securely affixed to the eyelet at the top portion of the float using a swivel and at least one clip, thereby accurately casting the float and the lead line with the hook out to a target destination into the water for fishing and prevents the lead line from being tangled to a fishing rig by spinning of the float. In one embodiment, the aerodynamic fishing assistant further comprises a main lead line attached to the eyelet on the top portion of the float using at least one clip. In one embodiment, the weight member is a lead aero dynamic weight member. The float has sufficient buoyancy to floatably support the weight member at the bottom portion of the float in the water.

In an embodiment, the aerodynamic fishing float is attached with different clips and different kind of attachments. One connection is with the 3-way swivel and attached to the clip. The connection with a swivel with the aerodynamic fishing float is running through the lead line connecting to the hook and baits. In one embodiment, the swivel is a 3-way swivel. In one embodiment, the swivel is a brass barrel swivel. The second connection is attached to the clip and connects to a pole. Wire connectors are attached at each joining portion and helps to connect through the 3-way swivel or the clip. In one embodiment, the clips are stainless-steel clips.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 illustrates an aerodynamic fishing assistant, incorporating the aspects of the present invention.

FIG. 2 illustrates a perspective view of the aerodynamic fishing assistant, incorporating the aspects of the present invention.

FIG. 3A illustrates attachments of aerodynamic fishing float, incorporating the aspects of the present invention.

FIG. 3B illustrates different components of aerodynamic fishing float, incorporating the aspects of the present invention.

FIG. 4A illustrates a side view of the aerodynamic fishing float, incorporating the aspects of the present invention.

FIG. 4B illustrates a bottom view of the aerodynamic fishing float, incorporating the aspects of the present invention.

FIG. 5A illustrates a 3-way swivel and a clip to be attached with the aerodynamic fishing float, incorporating the aspects of the present invention.

FIG. 5B illustrates attachment and components of the aerodynamic fishing float, incorporating the aspects of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

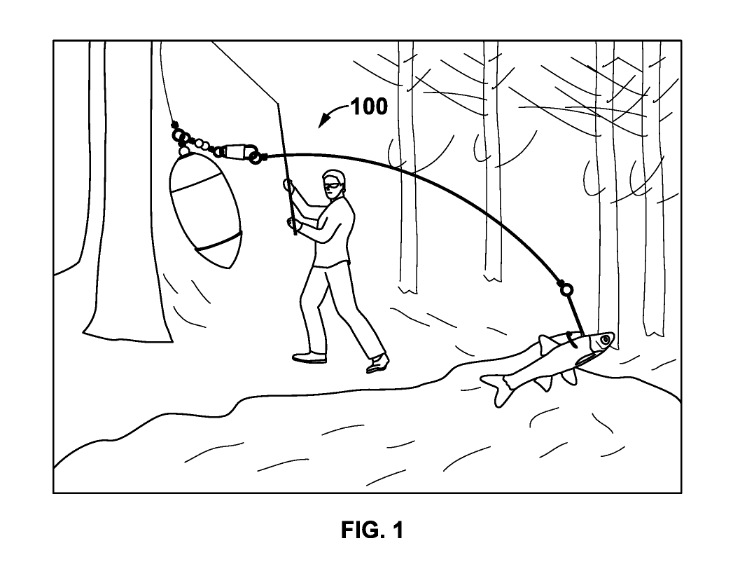

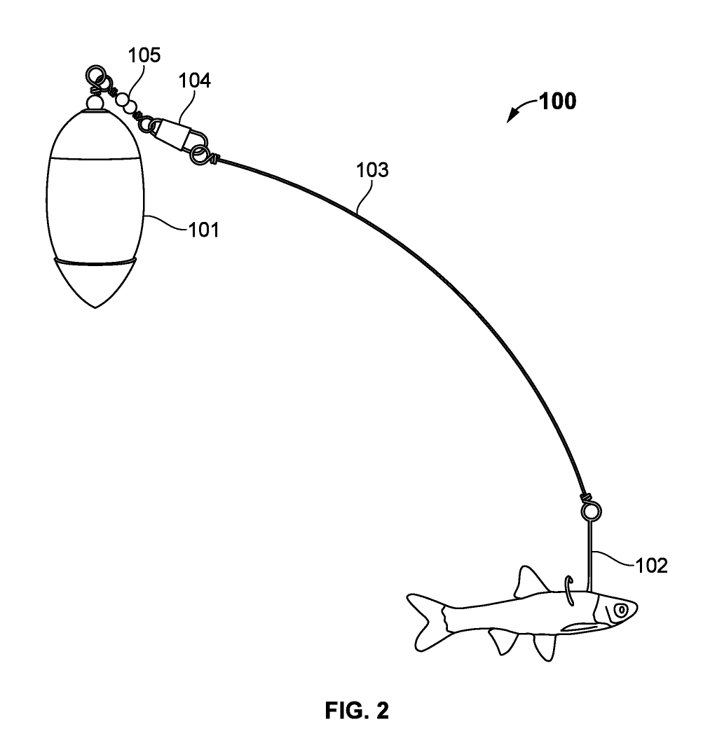

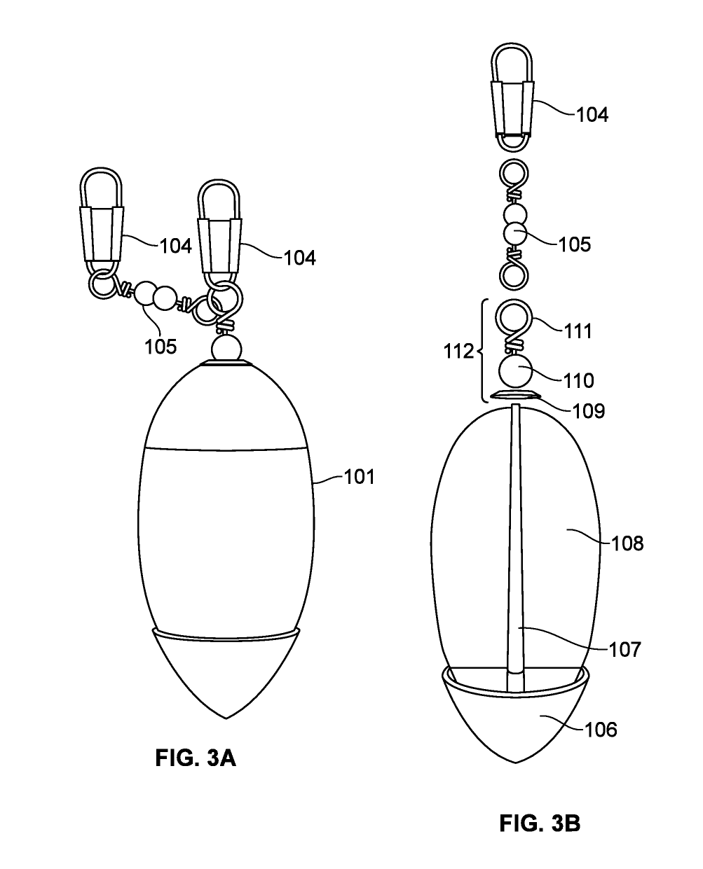

The present invention relates to an aerodynamic fishing assistant 100 as shown in FIG. 1, incorporating the aspects of the present invention. In an embodiment, the aerodynamic fishing assistant 100 has a specialized lead weight member 106 attached to a float or an aerodynamic float 101. In one embodiment, the aerodynamic float 101 includes an opening along its central longitudinal axis. The aerodynamic float 101 is attached to bait and hook 102 via a single lead line 103 as shown in FIG. 2. Further, the single lead line 103 is attached with the aerodynamic float 101 through a swivel 105 and clip 104. In one embodiment, the swivel 105 could be 3-way swivel. In one embodiment, the aerodynamic fishing assistant 100 further comprises a main lead line attached to the eyelet 111 (shown in FIG. 3B) on the top portion of the float 101 using at least one clip 104.

In a preferred embodiment, the aerodynamic float 101 is constructed of styrofoam or plastic. The aerodynamic float 101 is molded from very low density, closed cell EVA (ethylene-vinyl acetate) foam. The styrofoam is cast in 2 layers in a permanent mold, with the red dyed material near the top of the mold and white dyed material running from the red down to the bottom of the mold. After curing, the aerodynamic float 101 is removed from the mold and dip coated with a thin layer of UV resistant, translucent polymer vinyl coating. Further, the aerodynamic float 101 is thermally cured. The wire with the eyelet 111 and bead 110 is thrust through a cupped washer 109, through the float 101, and into a weight member or a lead aerodynamic weight 106 on the bottom of the float 101. In one embodiment, the weight 106 is adhesively bonded on a bottom portion of the aerodynamic float 110. The aerodynamic float 101 is wound to tighten against the bottom of the weight member 106. Further, the weight member 106 is touched with a very high temperature flame and flowed around the wire carefully, so the high temperature doesn't melt the EVA foam or degrade the adhesive bond.

FIG. 3A illustrates attachments of aerodynamic float 101, incorporating the aspects of the present invention. In an embodiment, the aerodynamic float 101 is attached with different clips 104 and different kind of attachments. One connection is with the 3-way swivel 105 and attached to the clip 104. The connection with a 3-way swivel 105 with the aerodynamic float 101 is running through the lead line 103 connecting to the hook and baits 102. The second connection is attached to the clip 104 and connects to a pole. Wire connectors are attached at each joining portion and helps to connect through the 3-way swivel 105 or the clip 104. In a preferred embodiment, the eyelet 111 on one end of the 3-way swivel 105 is cut, slid over in the top portion of the aerodynamic float 101, compressed, and spot welded to make it a solid loop again. Then two stainless-steel clips 104 are attached to the eyelet 111 using at least one 3-way swivel 105. In one embodiment, the lead line 103 with a hook 102 is securely affixed to the eyelet 111 at the top portion of the aerodynamic float 101 using a swivel 105 and at least one clip 104.

FIG. 3B illustrates different components of aerodynamic float 101, incorporating the aspects of the present invention. In an embodiment, the lower most portion of the aerodynamic float 101 consists of a weight member 106. The aerodynamic fishing assistant 100 includes a shaft 107. The shaft 107 comprises a first end and a second end, wherein the second end is configured to slidably positioned into the opening of the aerodynamic float 101 from a bottom portion and securely affixed to a top portion of the aerodynamic float 101 by a fastening assembly 112. In one embodiment, the fastening assembly 112 comprises a cupped washer 109, the bead 110, and the eyelet 111. The cupped washer 109 creates a frictionless surface between the aerodynamic float 101 and other connected hardware. The body portion 108 of the aerodynamic float 101 is made up of styrofoam or plastic.

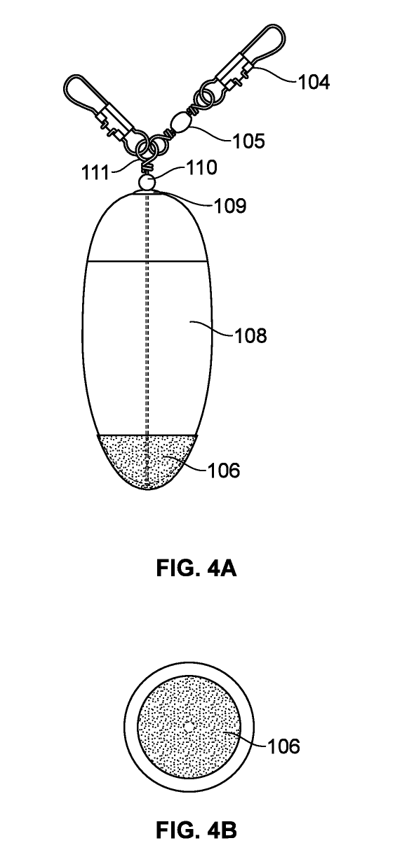

FIG. 4A illustrates a side view of the aerodynamic float 101, incorporating the aspects of the present invention. In an embodiment, the aerodynamic float 101 comes with two connections via wire connectors. One connection is with the 3-way swivel 105 and attached to the clip 104. The connection with a 3-way swivel 105 with the aerodynamic float 101 is running through the lead line 103 connecting to the hook and bait 102. The second connection is attached to the clip 104 and connects to a pole. The body portion 108 of the aerodynamic float 101 is made up of Styrofoam or plastic. The weight of the aerodynamic float 101 is maintained by the weight member 106. FIG. 4B illustrates a bottom view of the aerodynamic float 101, highlighting the lead aero dynamic weight 106 of the aerodynamic fishing assistant 100.

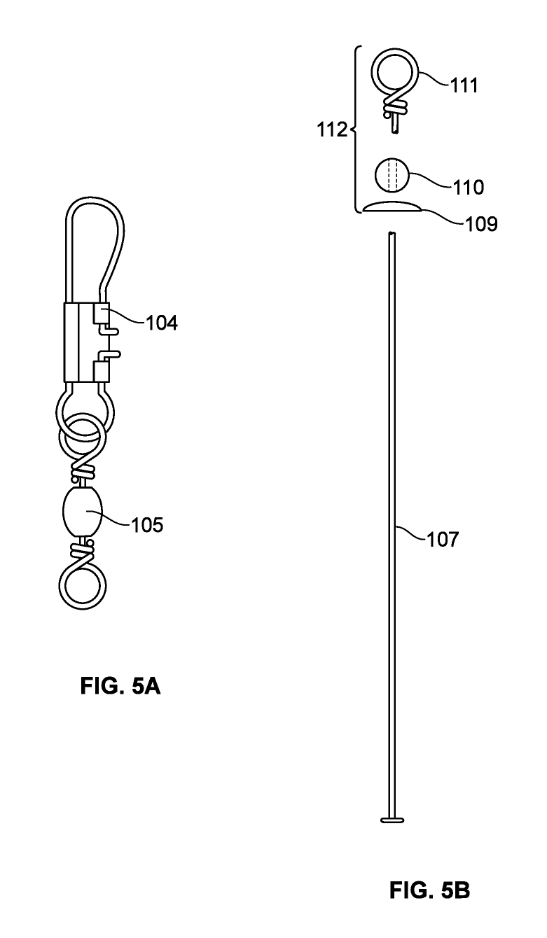

FIG. 5A illustrates a 3-way swivel 105 and a clip 104 to be attached with the aerodynamic float 101, incorporating the aspects of the present invention. The 3-way swivel 105 and a clip 104 are attached to the hook and bait 102 of the aerodynamic float 101. FIG. 5B illustrates attachment and components of the aerodynamic fishing float 101, incorporating the aspects of the present invention. In an embodiment, the aerodynamic float 101 is a cupped washer 109 to protect the aerodynamic float 101 and create a frictionless surface between the surface of the aerodynamic float 101 and other connected hardware. Attached to the top of the shaft 107 after the cupped washer 109 is a bead 110 for spacing. The shaft 107 has a lead line 103 that has a 3-way swivel 105 attached to it. The shaft 107 is configured to slidably positioned into the opening of the float 101 from the bottom portion and securely affixed to the top portion of the aerodynamic float 101 by a fastening assembly 112 includes the cupped washer 109, the bead 110, and the eyelet 111.

In a preferred embodiment, the aerodynamic fishing assistant 100, eliminates the uncontrolled swiveling of the lead line and fishing rig resulting in greater accuracy, longer casts, and the elimination of tangles with the use of the aero dynamic float 101. The aerodynamic float 101 eliminates swivelling of lead lines during casting, increasing accuracy. Further, aerodynamic float 101 eliminates tangles due to movement of leads during casting flight. It helps in increasing distance of cast. The aerodynamic float 101 is easy and quick to attach and remove. In another embodiment, the aerodynamic float 101 is used in conjunction with multiple rigs; where rig is free to swivel when in the water. The aerodynamic float 101 works as a normal float, when in water. Further, the aerodynamic float 101 helps to prevent loss of bait when casting.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. An aerodynamic fishing assistant, comprising:
a float includes an opening along its central longitudinal axis,
a shaft having a first end and a second end, wherein the second end is configured to slidably positioned into the opening of the float from a bottom portion and securely affixed to a top portion of the float by a fastening assembly comprising a cupped washer, a bead, and an eyelet;
a weight member adhesively bonded on the bottom portion of the float, and
a lead line with a hook securely affixed to the eyelet at the top portion of the float using a swivel and at least one clip, thereby accurately casting the float and the lead line with the hook and a bait out to a target destination into the water for fishing and prevents the lead line from being tangled to a fishing rig by spinning of the float.

2. The fishing assistant of claim 1, wherein the float is made of at least any one of a material includes Styrofoam® and plastic.

3. The fishing assistant of claim 1, wherein the float is made of an ethylene-vinyl acetate (EVA) foam.

4. The fishing assistant of claim 1, wherein the float is of an aerodynamic shaped member.

5. The fishing assistant of claim 1, further comprises a main lead line attached to the eyelet on the top portion of the float using at least one clip.

6. The fishing assistant of claim 1, wherein the float has sufficient buoyancy to floatably support the weight member at the bottom portion of the float in the water.

7. The fishing assistant of claim 1, wherein the weight member is a lead aero dynamic weight member.

8. The fishing assistant of claim 1, wherein the swivel is a 3-way swivel.

9. The fishing assistant of claim 1, wherein the swivel is a brass barrel swivel.

10. The fishing assistant of claim 1, wherein the clips are stainless-steel clips.

11. An aerodynamic fishing assistant, comprising:
a float includes an opening along its central longitudinal axis,
a shaft having a first end with a stopper and a second end, wherein the second end is configured to slidably positioned into the opening of the float from a bottom portion and securely affixed to a top portion of the float by a fastening assembly comprising a cupped washer, a bead, and an eyelet;
a weight member adhesively bonded on the bottom portion of the float, and
a lead line with a hook securely affixed to the eyelet at the top portion of the float using a swivel and at least one clip, and
a main line attached to the eyelet on the top portion of the float using at least one clip, thereby accurately casting the float and the fisher line with the hook and a bait out to a target destination into the water and prevents the lead line from being tangled to the main line from spinning of the float.

12. The fishing assistant of claim 11, wherein the float is made of at least any one of a material includes Styrofoam® and plastic.

13. The fishing assistant of claim 11, wherein the float is made of an ethylene-vinyl acetate (EVA) foam.

14. The fishing assistant of claim 11, wherein the float is of an aerodynamic shaped member.

15. The fishing assistant of claim 11, further comprises a single lead line attached to the eyelet on the top portion of the float using at least one clip.

16. The fishing assistant of claim 11, wherein the float has sufficient buoyancy to floatably support the weight member at the bottom portion of the float in the water.

17. The fishing assistant of claim 11, wherein the weight member is a lead aerodynamic weight member.

18. The fishing assistant of claim 11, wherein the swivel is a 3-way swivel.

19. The fishing assistant of claim 11, wherein the swivel is a brass barrel swivel.

20. The fishing assistant of claim 11, wherein the clips are stainless-steel clips.
